(19) United States
(12) Patent Application Publication
(10) Pub. No.: US 2012/0330466 A1
(43) Pub. Date: Dec. 27, 2012

(54) OPERATIONAL LOGIC FOR PRESSURE CONTROL OF A WELLHEAD

(76) Inventor: GEORGE JOEL RODGER, Houston, TX (US)

(21) Appl. No.: 13/169,859

(22) Filed: Jun. 27, 2011

(51) Int. Cl. G05D 7/06

(52) U.S. Cl. 700/282

(57) ABSTRACT

Methods and apparatus are provided for controlling production from a well by monitoring a parameter at a wellhead and adjusting a choke in an effort to maintain a desired parameter (e.g., a tubing head pressure (THP), bottom home pressure (BHP), a flow rate, or water cut (WC)). For some embodiments, a time window may be used for calculating a running average of parameter samples, and a proportional-integral-derivative (PID) control loop may be utilized to determine the difference between the running average and a parameter setpoint and to output a signal based on the difference to adjust the choke opening accordingly. In this manner, control of production from an individual well may be more accurate and reliable. Furthermore, for multiple wells coupled to a gathering center, maintaining a constant parameter for each of the multiple wells may enable stable operation of a gathering system and desired hydrocarbon production from each of the wells.

### BACKGROUND OF THE INVENTION

1. Field of the Invention

Embodiments of the present invention generally relate to producing hydrocarbons from a well and, more particularly, to controlling production from the well by maintaining a desired parameter for at least one production zone of the well.

2. Description of the Related Art

A hydrocarbon gathering system may comprise producing wells connected by gathering lines that transport production to a gathering center. The wells may be limited to producing a combined amount of production during a particular time frame. An adjustable choke may be used to restrict the flow from any particular well. Chokes are fixed or variable devices, such as flow chokes, valves, and orifice plates. Moreover, each well may have multiple completions (i.e., production zones), wherein each zone may be controlled by a separate choke. Further, each well may be a varied distance from the gathering center, which may affect the pressure of the flow traveling from a particular well to the gathering center. Based on parameters such as the production limitation and the distance from the gathering center, each well may be controlled to flow at a certain production rate.

### SUMMARY OF THE INVENTION

Embodiments of the present invention generally provide methods and apparatus for controlling production from a well by maintaining a constant parameter as measured at a wellhead.

One embodiment of the present invention is a method of producing fluid from a well. The method generally includes determining a parameter associated with production tubing disposed in the well and controlling an opening of a choke associated with the production tubing based on the parameter, wherein the controlling and the determining comprise using a proportional control and at least another numerical method, respectively.

Another embodiment of the present invention provides an apparatus for controlling production of fluid from a well. The apparatus generally includes at least one processor configured to receive an indication of a parameter associated with production tubing disposed in the well, determine a signal to control an opening of a choke associated with the production tubing based on the received indication of the parameter, wherein the at least one processor is configured to determine the signal and receive the indication by using a proportional control and at least another numerical method, respectively, and output the signal.

Another embodiment of the present invention provides a system. The system generally includes production tubing disposed in a well, a sensor for determining a parameter associated with the production tubing, a choke having an opening adjustable to control production of fluid from the well via the production tubing, and at least one processor. The at least one processor is typically configured to receive an indication of the parameter from the sensor and control the opening of the choke based on the received indication of the parameter, wherein the at least one processor is configured to control the opening and receive the indication by using proportional control and at least another numerical method, respectively.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary hydrocarbon gathering system, according to an embodiment of the present invention.

FIG. 2 illustrates an exemplary producing well having a choke for controlling fluid production, according to an embodiment of the present invention.

FIG. 3 is a flow diagram of exemplary operations for controlling production from a well based on a parameter of the well, according to an embodiment of the present invention.

FIG. 4 illustrates example operations for using a proportional-integral-derivative (PID) control loop and a running average of process variable samples in an effort to maintain a constant parameter of the well, according to an embodiment of the present invention.

FIG. 5 illustrates an implementation of the operations illustrated in FIG. 4, according to an embodiment of the present invention.

### DETAILED DESCRIPTION

Embodiments of the present invention provide techniques and apparatus for controlling production from a well by monitoring a parameter at a wellhead and adjusting a choke in an effort to maintain a desired parameter (e.g., monitoring a tubing head pressure (THP) and maintaining a desired THP). Other parameters that may be monitored and, in some cases, maintained comprise a bottom hole pressure (BHP), a flow rate, a water cut (WC), and the like. As used herein, the WC generally refers to a ratio (typically expressed as a percentage) of the water volume in the produced fluid to the total fluid volume. In the case of controlling a well based on the WC, the WC may be monitored, and the choke may be adjusted accordingly in an effort to maintain a desired production volume of a particular fluid. For simplicity, controlling a well based on THP, for the most part, will be described further here on out, although this description may apply to other embodiments of the invention involving other monitored parameters, such as BHP, flow rate, or WC.

Conventionally, an operator of a well calculated or otherwise determined what the opening of a choke (i.e., the choke position) would have to be to achieve a desired THP or flow rate and controlled the well based on this choke opening. However, issues related to the choke, such as erosion of the choke bean or errors in mathematical models for calculating the choke position, frequently prevented the optimal operating condition from being achieved. Therefore, controlling the well based on THP monitored at the wellhead may allow for more accurate and reliable control of the well, notwithstanding the passage of time and mechanical wear. Furthermore, maintaining a constant THP for each of a group of wells connected to a gathering center may enable well-controlled and stable operation of a gathering system and desired production from the wells.

Embodiments of the present invention generally relate to, but need not be limited to, wells which are controlled by back pressure (e.g., artificial lift or naturally flowing wells). With a naturally flowing well, THP is generally only due to the pressure of fluids flowing from the higher pressure reservoir to the lower pressure at the wellhead. There may be no influence to THP from injected fluids or other mechanisms used in an artificial lift well, consequently making it easier to control the well, or more specifically fluid flow produced by the well, based on THP. However, as described above, the well may also be controlled based on BHP or WC. Embodiments of the present invention may also apply to subsea applications.

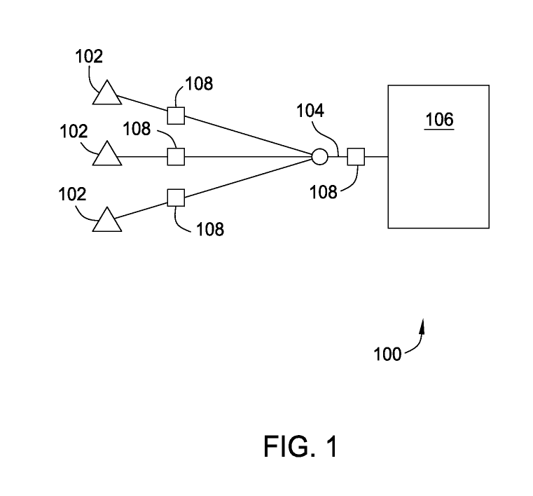

FIG. 1 illustrates an exemplary hydrocarbon gathering system 100, according to an embodiment of the present invention. Producing wells 102 (e.g., land-based naturally flowing wells) may be connected by gathering lines 104 that transport production to, for example, a gathering center 106. At each well 102, measurement equipment 108 may be installed to measure the pressure and volume of production. A determination may be made (e.g., by an operator or a software package) that the wells 102 may be limited to produce a combined amount of production during a particular time frame. Further, each well 102 may be a varied distance from the gathering center 106, which may affect the pressure of the flow traveling from a particular well to the gathering center 106. Based on parameters such as the production limitation and the distance from the gathering center, each well 102 may be instructed to flow at a certain production rate by operating at a certain desired THP (i.e., a THP setpoint). The THP setpoint may be the optimal operating condition for THP at each respective well 102.

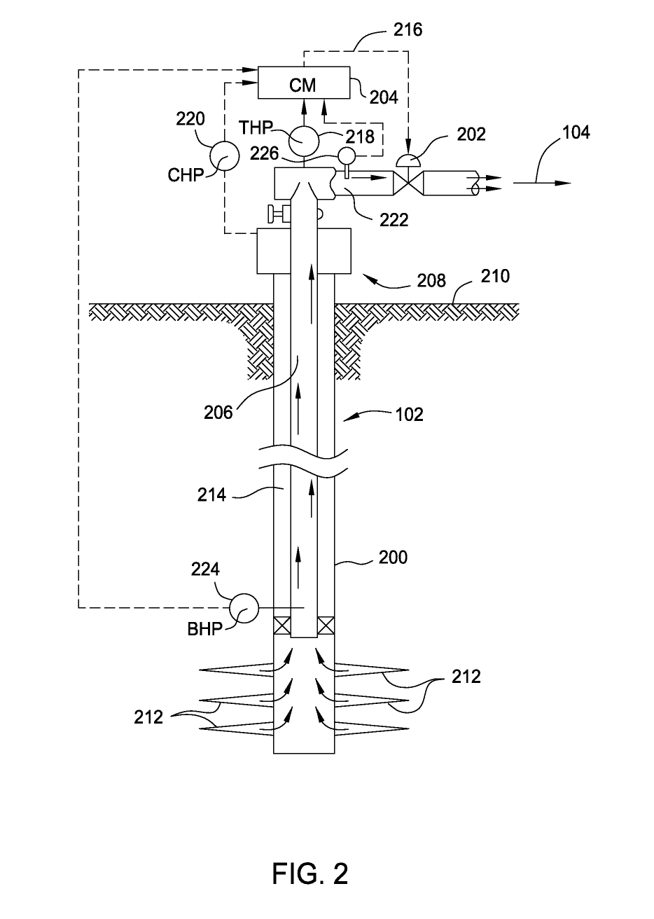

FIG. 2 illustrates an exemplary producing well 102 having a choke 202 for controlling fluid production, according to an embodiment of the present invention. The well 102 may have a casing 200 cemented in the wellbore after drilling and may be capped by a wellhead 208. Production tubing 206 may be suspended from the wellhead 208 and may extend through the casing 200 to near the bottom of the well 102. Hydrocarbons may be produced via perforations 212 that have been shot into a formation, such that the hydrocarbons flow from the formation to the wellhead 208 via the production tubing 206.

To control the flow rate of production, the opening of the choke 202 may be adjusted. The choke 202 may be mounted on a wing line 222 or other conduit, which may be coupled to the wellhead 208 (e.g., via what is known as a “Christmas tree”) and to the gathering center 106 via a gathering line 104 at the earth surface 210. The opening of the choke 202 may be controlled and adjusted by a control module (CM) 204. For some embodiments, the CM 204 may be disposed locally at or near the well 102. For other embodiments, the CM 204 may be disposed remotely from the well, such as at the gathering center 106, and may control more than one well. The CM 204 may receive data concerning a casing head pressure (CHP) (measured by a CHP sensor 220 disposed at or near the top of an annular space 214 between the casing 200 and the production tubing 206), the THP (measured by a THP sensor 218 disposed at or near the top of the tubing 206), the BHP (measured by a BHP sensor 224 disposed at or near the depth of the producing formation), the WC (measured by a WC meter 226 disposed on the wing line 222), or any combination thereof. As used herein, the CHP generally refers to the pressure in the annular space 214 as measured at or near the wellhead 208, the THP generally refers to the pressure in the production tubing 206 measured at or near the wellhead 208 (e.g., where the tubing completion meets the Christmas tree), the BHP generally refers to the pressure at or near the depth of the producing formation, and the WC generally refers to the ratio of water produced compared to the volume of total liquids produced. The THP, CHP, and BHP sensors 218, 220, 224 may be any of various suitable sensors for measuring pressure, such as pressure gauges or fiber optic sensors. As a suitable example of the WC meter 226, U.S. Pat. No. 7,834,312 entitled “Water Detection and 3-Phase Fraction Measurement Systems,” which is herein incorporated by reference, describes an infrared optical fiber system capable of determining, for example, the percentages of water, oil, and hydrate inhibitor.

Based on the THP measured by the THP sensor 218, the CM 204 may output a signal 216 to adjust the opening of the choke 202. For some embodiments, the choke 202 may comprise an electrical or hydraulic actuator, wherein the actuator may be used to adjust the opening of the choke 202 upon receiving the signal 216.

Traditionally, when an operator of the well 102 received instruction to operate the well 102 at a certain THP, the operator calculated what the opening of the choke 202 would have to be to achieve the requested THP. However, calculation of the choke opening may not always yield the requested THP due to, for example, erosion of the choke bean. For example, although the operator may calculate the choke 202 would have to be 50% open (e.g., 32/64 discrete choke positions relative to a diameter of the maximum choke opening) to achieve a requested THP, due to erosion, the choke opening may in fact have to be 31/64 to achieve the requested THP. Therefore, rather than determining a choke opening, embodiments of the invention operate the well 102 by measuring THP and controlling the choke opening accordingly to maintain a constant desired THP (i.e., the THP setpoint). However, as described above, the choke opening may also be controlled to maintain a constant desired BHP, flow rate, or WC (i.e., a desired target value of the parameter being measured).

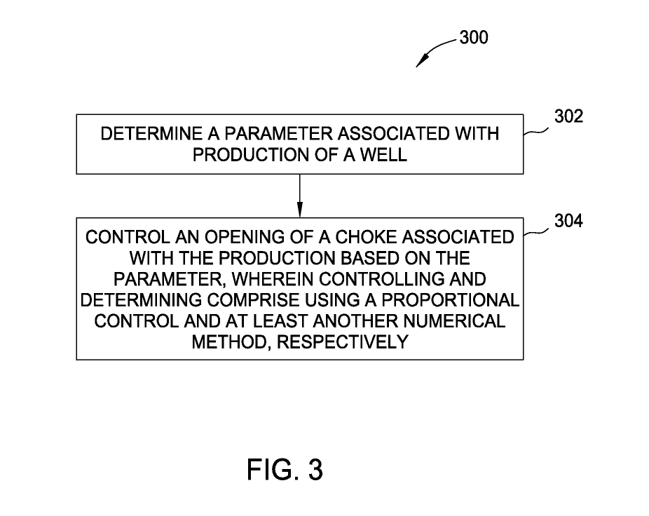

FIG. 3 illustrates example operations 300 for controlling production from a well, in accordance with certain embodiments of the present invention. The operations 300 may be performed, for example, by at least one processor (e.g., a CM 204) disposed locally at the well or remotely, for example, at a gathering center. At 302, the processor may determine a parameter (e.g., THP, BHP, or WC) associated with production tubing disposed in the well. For example, the processor may receive an indication of the THP as determined by the THP sensor 218. At 304, the processor may control an opening of a choke associated with the production tubing based on the parameter. For example, the CM 204 may output a signal 216 to control the choke opening. The controlling and the determining described above may comprise using a proportional control and at least another numerical method (e.g., at least one of a running average and a delay time), as will be described further herein. These operations 300 may be repeated as long as desired by the well operator.

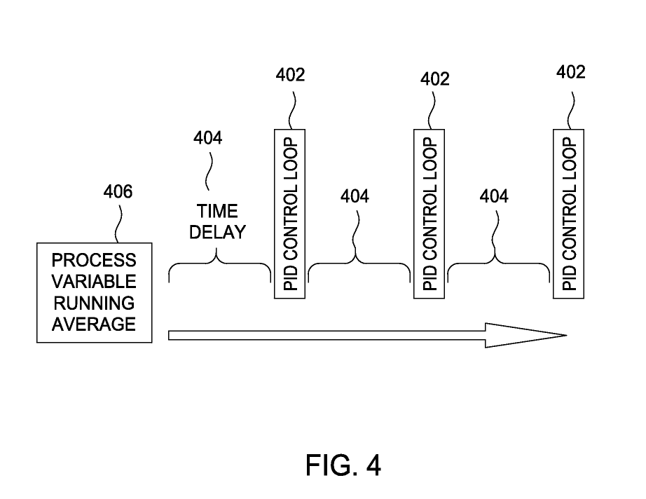

FIG. 4 illustrates example operations for using a proportional-integral-derivative (PID) control loop 402 and a running average 406 of process variable samples in an effort to maintain a constant parameter (e.g., THP, BHP, flow rate, or WC), according to an embodiment of the present invention. The techniques may be implemented by one or more processors (e.g., the CM 204) disposed locally at the well 102 or remotely, such as at the gathering center 106. For some embodiments, either one of these techniques may be used by itself to control production from the well, rather than in combination as shown in FIG. 4. The PID control loop 402 may calculate an error value as the difference between a measured THP and the requested THP the THP setpoint). For some embodiments, the PID control loop 402 may use only one or two modes (e.g., P or PI) to provide the appropriate system control. The processor(s) may then attempt to reduce the error (i.e., the difference between the measured and requested THPs) by adjusting the opening of the choke 202 (step 304 in FIG. 3). For example, the choke 202 may comprise an electrical actuator, as described above, and the CM 204 may output a signal (216 in FIG. 2) to the electrical actuator to adjust the opening of the choke 202.

In an effort to filter noise (e.g., high frequency spikes) generated from THP measurements, a time averaging window 406 may sample the THP during a time window to form THP samples, and calculate a running average of the THP samples (step 302 in FIG. 3). For some embodiments, the PID control loop 402 may calculate the error value as a difference between the running average and the THP setpoint. The length of the time averaging window 406 may vary for each well, and may be determined by trial and error. For example, having too short a window 406 may cause the CM 204 to over adjust the opening of the choke 202 for THP measurements that may actually be caused by noise or other transient signals. However, having too long a window 406 may prevent the CM 204 from sufficiently adjusting the opening of the choke 202 to maintain the constant THP.

A minimal change at the choke 202 may cause the well 102 to become unstable (e.g., the well 102 may start to slug), and some wells may take longer to stabilize than other wells. Therefore, the PID control loop 402, by itself, may continue chasing itself to minimize the error, particularly for wells that take longer to stabilize, and therefore, may no longer maintain the constant THP. However, for some embodiments of the present invention, each action performed by the PID control loop 402 (e.g., at an end of the time averaging window 406) may be separated by a time delay 404 to allow time for the well 102 to stabilize. In other words, after termination of the time averaging window 406, the PID control loop 402 may wait a time delay 404 before repeating the determination whether to adjust the opening of the choke 202. The length of the time delay 404 may vary for each well and may be determined by trial and error. However, for some embodiments, the time delay 404 need not be utilized, particularly for wells that take a shorter time to stabilize upon adjustments of the choke opening.

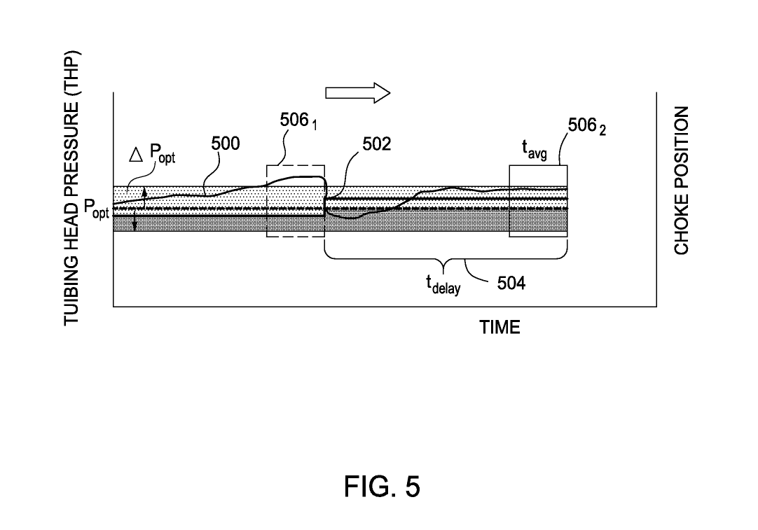

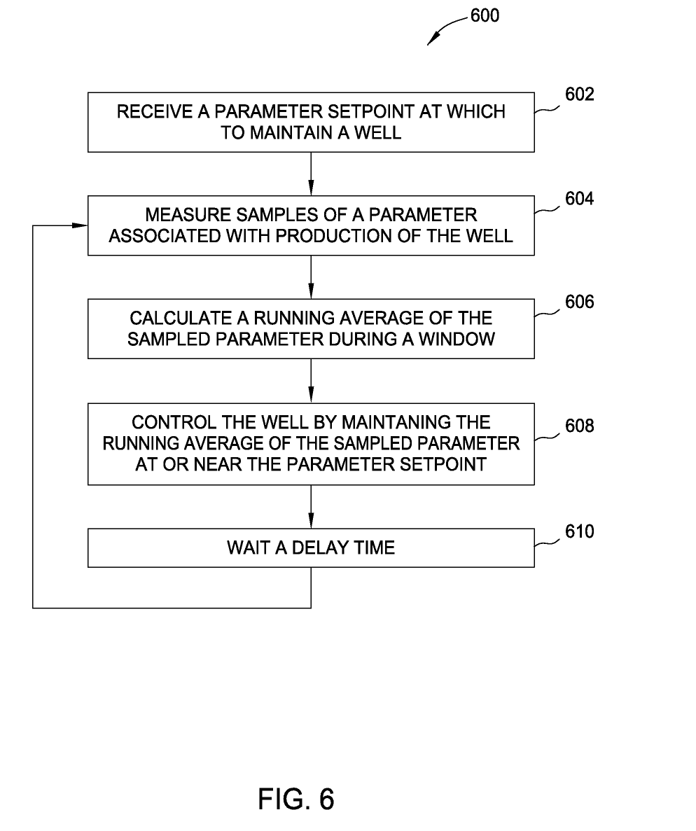

FIG. 5 illustrates an implementation of the operations illustrated in FIG. 4, according to an embodiment of the present invention. An operator of a well 102 may receive instructions to operate the well 102 at a certain THP setpoint (Pₒₚₜ). Further, the operator may also receive or determine a pressure range around Pₒₚₜ in which to maintain the well 102 (ΔPₒₚₜ, the dead band). As described above, the THP 500 may be measured by a sensor, such as a pressure gauge, at the top of the production tubing 206. During a first time averaging window 506₁, the CM 204 may determine that a running average of the THP of the well 102 is outside the allowable THP range (Pₒₚₜ±ΔPₒₚₜ) as illustrated in FIG. 5. Therefore, after calculating the error value between the measured THP (i.e., as a result of the first time averaging window 506₁) and Pₒₚₜ, the CM 204 may adjust the opening of the choke 202, as indicated at 502, in an effort to reduce the error and maintain a constant THP. The next action performed by the PID control loop 402 may be delayed by time delay (t_{delay}) 504. During a second time averaging window 506₂, the CM 204 may determine that the running average of the THP of the well 102 is within the allowable THP range, as illustrated in FIG. 5. Therefore, the opening of the choke 202 may not be adjusted.

Using at least a PID control loop (i.e., P, PI, or PID) and at least another numerical method (e.g., a running average of a process variable or a delay time) as described herein may allow a well to be maintained at a constant parameter (e.g., THP, BHP, or WC), and hence, a constant flow rate. Maintaining a constant parameter for each of a group of wells that are connected to a gathering center may allow for stable operation of a gathering system and more accurate and reliable production from the wells.

While the foregoing is directed to embodiments of the present invention, other and further embodiments of the invention may be devised without departing from the basic scope thereof, and the scope thereof is determined by the claims that follow.

1. A method of producing fluid from a well, comprising:
determining a parameter associated with production of the well; and
controlling an opening of a choke associated with the production based on the parameter, wherein the controlling and the determining comprise using a proportional control and at least another numerical method, respectively.

2. The method of claim 1, wherein the other numerical method comprises using at least one of a running average and a delay time.

3. The method of claim 2, wherein determining the parameter comprises:
sampling the parameter during a time window to form parameter samples; and
calculating the running average of the parameter samples.

4. The method of claim 2, wherein the proportional control is based on the running average and a setpoint of the parameter.

5. The method of claim 4, wherein controlling the opening of the choke comprises maintaining the parameter at or near the setpoint of the parameter.

6. The method of claim 4, wherein using the proportional control comprises using the proportional control based on the running average, the setpoint of the parameter, and a range around the setpoint.

7. The method of claim 4, wherein the choke comprises an electrical actuator and the proportional control outputs a signal to the electrical actuator.

8. The method of claim 3, further comprising:
after termination of the time window, waiting the delay time; and
after termination of the delay time, repeating determining the parameter and controlling the opening of the choke.

9. The method of claim 3, wherein controlling the opening of the choke comprises adjusting the opening of the choke at an end of the time window.

10. The method of claim 1, wherein the parameter comprises at least one of a tubing head pressure (THP), a bottom hole pressure (BHP), a flow rate, and a water cut (WC).

11. The method of claim 1, wherein the well comprises a naturally flowing well.

12. The method of claim 1, wherein the well comprises a subsea well.

13. The method of claim 4, wherein the setpoint of the parameter is an optimal operating condition for the parameter.

14. The method of claim 1, wherein using the proportional control comprises using a proportional-integral (PI) control.

15. The method of claim 14, wherein using the PI control comprises using a proportional-integral-derivative (PID) control.

16. An apparatus for controlling production of fluid from a well, comprising:
at least one processor configured to:
receive an indication of a parameter associated with the production;
determine a signal to control an opening of a choke associated with the production based on the received indication of the parameter, wherein the at least one processor is configured to determine the signal and receive the indication by using a proportional control and at least another numerical method, respectively; and
output the signal.

17. The apparatus of claim 16, wherein the other numerical method comprises using at least one of a running average and a delay time.

18. The apparatus of claim 17, wherein the at least one processor is configured to receive the indication of the parameter by:
sampling the parameter during a time window to form parameter samples; and
calculating the running average of the parameter samples.

19. The apparatus of claim 17, wherein the proportional control is based on the running average and a setpoint of the parameter.

20. The apparatus of claim 19, wherein the at least one processor is configured to determine the signal by maintaining the parameter at or near the setpoint of the parameter.

21. The apparatus of claim 18, wherein the at least one processor is configured to:
wait the delay time after termination of the time window; and
repeat, after termination of the delay time, receiving the indication of the parameter, determining the signal, and outputting the signal.

22. The apparatus of claim 16, wherein the at least one processor is configured to:
receive another indication of another parameter associated with other production of fluid from another well;
determine another signal to control another opening of another choke associated with the other production based on the other received indication of the other parameter; and
output the other signal.

23. The apparatus of claim 16, wherein using the proportional control comprises using a proportional-integral (PI) control.

24. A system comprising:
production tubing disposed in a well;
a sensor for determining a parameter associated with the production tubing;
a choke having an opening adjustable to control production of fluid from the well via the production tubing; and
at least one processor configured to:
receive an indication of the parameter from the sensor; and
control the opening of the choke based on the received indication of the parameter, wherein the at least one processor is configured to control the opening and receive the indication by using proportional control and at least another numerical method, respectively.

25. The system of claim 24, wherein the other numerical method comprises using at least one of a running average and a delay time.

26. The system of claim 25, wherein the at least one processor is configured to receive the indication of the parameter by:
sampling the parameter during a time window to form parameter samples; and
calculating the running average of the parameter samples.

27. The system of claim 25, wherein the proportional control is based on the running average and a setpoint of the parameter.

28. The system of claim 27, wherein the at least one processor is configured to control the opening of the choke by maintaining the parameter at or near the setpoint of the parameter.

29. The system of claim 26, wherein the at least one processor is configured to:
wait the delay time after termination of the time window; and
repeat, after termination of the delay time, receiving the indication of the parameter and controlling the opening of the choke.

30. The system of claim 26, wherein the at least one processor is configured to control the opening of the choke by outputting a signal to adjust the opening of the choke at an end of the time window.

31. The system of claim 24, wherein the at least one processor is disposed locally at the well.

32. The system of claim 24, further comprising a gathering center, wherein the at least one processor is disposed remotely at the gathering center.

33. The system of claim 24, wherein using the proportional control comprises using a proportional-integral (PI) control.
